(19) United States
(12) Patent Application Publication
(10) Pub. No.: US 2015/0269319 A1
(43) Pub. Date: Sep. 24, 2015

(54) METHOD AND COMPUTING DEVICE FOR RESTRICTING ACCESS TO INFORMATION REGARDING AN ENCOUNTER

(71) Applicant: Mckesson Financial Holdings, Hamilton (BM)

(72) Inventors: Michelle Sporleder, Lohman, MO (US); Kara Erlandsen, Marietta, GA (US)

(73) Assignee: Mckesson Financial Holdings, Hamilton (BM)

(21) Appl. No.: 14/221,811

(22) Filed: Mar. 21, 2014

(51) Int. Cl. G06F 19/00

(52) U.S. Cl. CPC G06F 19/322; G06F 19/328

(57) ABSTRACT

A method, a computing device and a computer program product are provided in order to selectively restrict access to information regarding an encounter. In the context of a method, a request is received from a patient to restrict access to records and documentation associated with at least a portion of an encounter. The method may also include causing an indication of restricted access to be presented in conjunction with a screen display, such as a schedule view, a chart view, an encounter view or a claim, associated with the encounter. The method may further include preventing records and documentation associated with the at least a portion of the encounter from being provided to a party associated with payment of claims for the patient, such as an insurance carrier or other payer.

### TECHNOLOGICAL FIELD

An example embodiment of the present invention relates generally to restricting access to information regarding an encounter and, more particularly, to a method, a computing device and a computer program product for selectively preventing records and documentation associated with at least a portion of an encounter from being provided to a party associated with payment of claims for the patient.

### BACKGROUND

Following an encounter with a medical provider, such as an office visit, a consultation or the like, and following a test, a procedure or the like, records and documentation associated with the encounter, test, procedure or the like are routinely provided to a payer, such as an insurance company that has insured the patient. Based upon the records and documentation, the payer may pay the medical practice for all or a portion of services rendered during the encounter, test, procedure or the like. To permit evaluation of the records and documentation associated with an encounter, test, procedure or the like, the health information systems and other computer systems of the medical practice are generally configured to provide a wealth of information to the payers including information regarding all of the encounters, tests, procedures or the like that the patient has undergone.

Even though some patients willingly permit information regarding some of their encounters, tests, procedures or the like to be provided to a payer to facilitate payment or reimbursement, these same patients may not wish for information regarding certain ones of their encounters, tests, procedures or the like to be provided to the payer, such as in an instance in which an encounter, test, procedure or the like could be considered embarrassing, unflattering, controversial, etc. In contrast to the prior Health Insurance Portability and Accountability Act (HIPAA) rules that provided for a more fulsome provision of information regarding the encounters, tests, procedures or the like of a patient following patient consent, the HIPAA Omnibus rule that became effective in October 2013 requires that records and documentation associated with an encounter, test, procedure or the like not be provided to a payer in an instance in which the patient requests that the records and documentation not be provided to the payer and the patient pays in full at the time of the encounter, test, procedure or the like.

As noted above, however, the health information systems and other computer systems of a medical practice are generally configured to provide the records and documentation of the encounters, tests, procedures or the like of a patient who has previously consented with no capability of segregating the records and documentation associated with those encounters, tests, procedures or the like for a patient that should be provided to a payer from the records and documentation associated with an encounter, test, procedure or the like that should not be provided to a payer. A risk therefore exists that records and documentation that a patient has requested not be provided to the payer are actually inadvertently provided to the payer, such as along with records and documentation associated with other encounters, tests, procedures or the like of the patient and to which the patient has consented.

### BRIEF SUMMARY

A method, a computing device and a computer program product are provided in accordance with an example embodiment in order to selectively restrict access to information regarding an encounter. As such, the method, computing device and computer program product of an example embodiment provide a mechanism for permitting a medical provider or other source of medical records and documentation to be alerted of a patient's request to restrict access to records and documentation and to correspondingly prevent those records and documentation from being provided to a party associated with payment of the claims for the encounter. Thus, the method, computing device and computer program product of an example embodiment may facilitate compliance with the HIPAA Omnibus rule while concurrently facilitating compliance with a patient directive.

In one embodiment, a method for restricting access to information regarding an encounter is provided that includes receiving a request from a patient to restrict access to records and documentation associated with at least a portion of an encounter. The method of this embodiment also includes causing, with processing circuitry, an indication of restricted access to be presented in conjunction with a screen display, such as a schedule view, a chart view, an encounter view or a claim, associated with the encounter. In this embodiment, the method also includes preventing records and documentation associated with the at least a portion of the encounter from being provided to a party associated with payment of claims for the patient, such as an insurance carrier or other payer.

The method of an example embodiment may also include honoring the request by causing the indication of restricted access to be presented and by preventing records and documentations from being provided only in an instance in which the patient provides payment by a conclusion of the encounter. The method of an example embodiment may also include excluding the encounter from a report that provides information regarding the patient including one or more encounters with the patient. The method of an example embodiment may prevent records and documentation associated with the at least a portion of the encounter from being provided by preventing information regarding tests associated with the encounter from being provided to the party associated with payment of claims for that patient. In one embodiment, the method may also include receiving a request from the patient to eliminate the restricted access following the receiving, causing and preventing steps. In response to the request to eliminate the restricted access, the method of this embodiment may provide access to the records and documentation associated with the at least a portion of the encounter to the party associated with payment of claims for the patient.

In another embodiment, a computing device is provided for restricting access to information regarding an encounter. The computing device includes processing circuitry configured to receive a request from a patient to restrict access to records and documentation associated with at least a portion of the encounter. The processing circuitry of this embodiment may also be configured to cause an indication of restricted access to be presented in conjunction with a screen display, such as a schedule view, a chart view, an encounter view or a claim, associated with the encounter. In this embodiment, the computing device may also be configured to prevent records and documentation associated with the at least a portion of the encounter from being provided to a party associated with payment of claims for the patient, such as an insurance carrier or other payer.

The processing circuitry of an example embodiment may be further configured to honor the request by causing the indication of restricted access to be presented and by preventing records and documentation from being provided only in an instance in which the patient provides payment by conclusion of the encounter. The processing circuitry of an example embodiment may also be configured to exclude the encounter from a report that provides information regarding the patient including one or more encounters with the patient. In one embodiment, the processing circuitry may be configured to prevent records and documentation associated with the at least a portion of the encounter from being provided by preventing information regarding tests associated with the encounter from being provided to the party associated with payment of claims for the patient. The processing circuitry of an example embodiment may also be configured to receive a request from the patient to eliminate the restricted access following the receiving, causing and preventing steps. In response to the request to eliminate the restricted access, the processing circuitry of this embodiment may be also configured to provide access to the records and documentation associated with the at least a portion of the encounter to the party associated with the payment of claims for the patient.

In a further embodiment, a computer program product is provided for restricting access to information regarding an encounter. The computer program product includes a non-transitory computer readable medium having program code stored thereon with the program code including program code instructions configured, upon execution, to receive a request from a patient to restrict access to records and documentation associated with at least a portion of an encounter. The program code of this embodiment may also include program code instructions configured, upon execution, to cause an indication of restricted access to be presented in conjunction with a screen display, such as a schedule view, a chart view, an encounter view or a claim, associated with the encounter. In this embodiment, the program code may also include program code instructions configured, upon execution, to prevent records and documentation associated with the at least a portion of the encounter from being provided to a party associated with payment of claims for the patient, such as an insurance carrier or other payer.

The program code of one example embodiment may also include program code instructions configured, upon execution, to honor the request by causing the indication of restricted access to be presented and by preventing records and documentation from being provided only in an instance in which the patient provides payment by conclusion of the encounter. The program code of an example embodiment may also include program code instructions configured, upon execution, to exclude the encounter from a report that provides information regarding the patient including one or more encounters with the patient. The program code instructions that are configured to prevent records and documentation associated with the at least a portion of the encounter from being provided may, in one embodiment, include program code instructions configured to prevent information regarding tests associated with the encounter from being provided to the party associated with payment of claims for the patient.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a block diagram of a computing device including processing circuitry that may be specifically configured in accordance with an example embodiment of the present invention;

FIG. 2 is a flowchart illustrating the operations performed, such as by the computing device of FIG. 1, in accordance with an example embodiment of the present invention;

FIG. 3 is a schedule view associated with an encounter that includes an indication of restricted access in accordance with an example embodiment of the present invention;

FIG. 4 is a chart/encounter view associated with an encounter that includes an indication of restricted access in accordance with an example embodiment of the present invention;

FIG. 5 is an encounter summary view associated with an encounter that includes an indication of restricted access in accordance with an example embodiment of the present invention;

FIG. 6 is a chart summary view associated with an encounter that includes an indication of restricted access in accordance with an example embodiment of the present invention; and

FIG. 7 is a billing view associated with an encounter that includes an indication of restricted access in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A method, computing device and computer program product are provided in accordance with example embodiments of the present invention in order to selectively restrict access to information regarding an encounter. In this regard, a patient may request that access to records and documentation associated with at least a portion of an encounter including, for example, tests, procedures or the like associated with the encounter, be restricted. The method, computing device and computer program product of an example embodiment may alert a medical provider as to the restrictions on access to records and documentation associated with at least a portion of the encounter, such as by providing an indication of the restricted access on one or more screen displays associated with the encounter. The method, computing device and computer program product may also prevent access to records and documentation associated with at least a portion of the encounter from being provided to a payer or other party associated with payment of claims for the patient. Thus, the method, computing device and computer program product of an example embodiment facilitate compliance with a request by the patient for restricted access and, consequently, facilitate compliance with the HIPAA Omnibus rule.

Although various types of computing devices may be utilized to restrict access to information regarding an encounter, the computing device of an example embodiment may be a personal computer, a laptop computer, a tablet computer, a computer workstation or the like of a medical provider that is creating a record of an encounter with a patient. Alternatively, the computing device may be a server or other network-based computing device that interacts with a computer system of a medical provider in order to perform certain functionalities, such as to restrict access to information regarding an encounter.

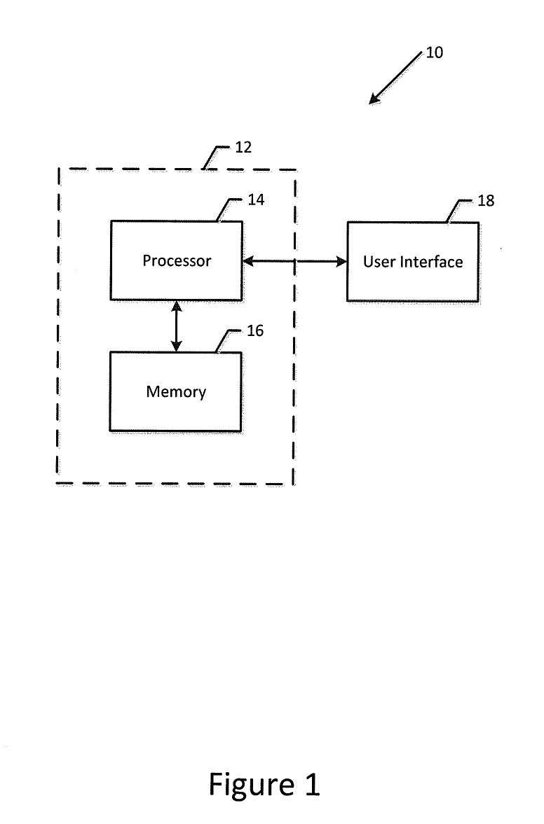

Regardless of the manner in which the computing device is embodied, the computing device 10 of one embodiment may be generally depicted as shown in FIG. 1 so as to include or to be associated and in communication with processing circuitry 12 that is configurable to perform functions in accordance with one or more example embodiments disclosed herein. In this regard, the processing circuitry may be configured to perform and/or control performance of one or more functionalities of the computing device in accordance with various example embodiments, and thus may provide means for performing functionalities of the computing device. The processing circuitry may be configured to perform data processing, application execution and/or other processing and management services according to one or more example embodiments.

In some example embodiments, the processing circuitry 12 may include a processor 14 and, in some embodiments, such as that illustrated in FIG. 1, may further include memory 16. The processing circuitry may be in communication with or otherwise control a user interface 18, such as a display, a keyboard and/or other input/output mechanisms and, in some embodiments, may also include a communication interface for communicating with other computing systems. As such, the processing circuitry may be embodied as a circuit chip (e.g., an integrated circuit chip) configured (e.g., with hardware, software or a combination of hardware and software) to perform operations described herein.

The processor 14 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor may comprise a plurality of processors. The plurality of processors may be in operative communication with each other and may be collectively configured to perform one or more functionalities of the computing device 10 as described herein. The plurality of processors may be embodied on a single computing device or distributed across a plurality of computing devices collectively configured to function as the computing device. In some example embodiments, the processor may be configured to execute instructions stored in the memory 16 or otherwise accessible to the processor. As such, whether configured by hardware or by a combination of hardware and software, the processor may represent an entity (e.g., physically embodied in circuitry—in the form of processing circuitry 12) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform one or more operations described herein.

In some example embodiments, the memory 16 may include one or more non-transitory memory devices such as, for example, volatile and/or non-volatile memory that may be either fixed or removable. In this regard, the memory may comprise a non-transitory computer-readable storage medium. It will be appreciated that while the memory is illustrated as a single memory, the memory may comprise a plurality of memories. The plurality of memories may be embodied on a single computing device or may be distributed across a plurality of computing devices collectively configured to function as the computing device 10. The memory may be configured to store information, data, applications, instructions and/or the like for enabling the computing device to carry out various functions in accordance with one or more example embodiments. For example, the memory may be configured to buffer input data for processing by the processor 14. Additionally or alternatively, the memory may be configured to store instructions for execution by the processor. As yet another alternative, the memory may include one or more databases that may store a variety of files, contents or data sets, such as electronic health records for a plurality of patients. Among the contents of the memory, applications may be stored for execution by the processor in order to carry out the functionality associated with each respective application. In some cases, the memory may be in communication with one or more of the processor or the user interface 18 via a bus or buses for passing information among components of the computing device.

Having now described a computing device 10 configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

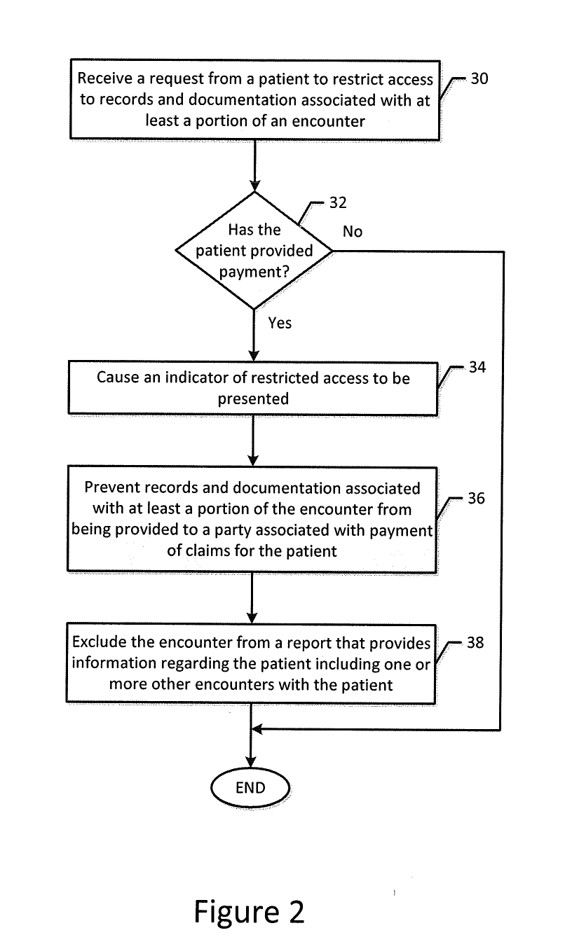

Referring now to FIG. 2, the operations performed, such as by the computing device 10 of FIG. 1, in accordance with an example embodiment of the present invention are illustrated. As shown in block 30 of FIG. 2, the computing device may include means, such as the processing circuitry 12, the processor 14, the user interface 18 or the like, for receiving a request from a patient to restrict access to records and documentation associated with at least a portion of an encounter. In this regard, an encounter may be a visit to a medical provider, such as for a checkup, a follow-up visit, a physical, a consultation or other type of visit. Additionally, a wide variety of medical providers may have encounters with patients and, as such, may advantageously adopt an example embodiment of the present invention in order to selectively restrict access to information regarding the encounter. As used herein, however, it is noted that a medical provider may include not only a physician or other licensed practitioner, but also the staff of a medical practice.

During the encounter or prior to the encounter, the patient may request that access be restricted to records and documentation associated with the encounter. This request may be provided orally by the patient, in writing by the patient or otherwise. In addition, this request for restricted access to the records and documentation associated with a particular encounter may be made by the patient even though the patient may have previously provided a more general HIPAA waiver that otherwise permits the medical provider to share the records and documentation of the various encounters of the patient with a payer.

In one example embodiment, a request by a patient to restrict access to records and documentation associated with the encounter is only honored in an instance in which the patient provides payment in full by the conclusion of the encounter, such as by the point in time at which the patient is checking out. Thus, the computing device 10 of this example embodiment may include means, such as the processing circuitry 12, the processor 14, the user interface 18 or the like, for determining whether the patient has provided payment by the conclusion of the encounter, such as based upon input provided by the medical provider. See block 32 of FIG. 2. In an instance in which the patient has provided payment in full by the conclusion of the encounter, the computing device may be configured to honor the request for restricted access to the records and documentation of the encounter, as described below. Alternatively, in an instance in which the patient has not paid in full for the services rendered during the encounter by the conclusion of the encounter, the request by the patient to restrict access to records and documentation associated with a particular encounter may not be honored and, instead, the request may be dismissed such that records and documentation associated with the encounter may be provided to the payer.

In response to the request from the patient to restrict access to records and documentation associated with the encounter and in an instance in which it is determined that the request will be honored, the processing circuitry 12, such as the processor 14, may cause an indication of restricted access to be stored in conjunction with a record of the encounter, such as in memory 16. As such, the processing circuitry, such as the processor, may flag the encounter as being of restricted access.

In an instance in which the patient has provided payment by the conclusion of the encounter, the computing device 10 may include means, such as the processing circuitry 12, the processor 14, the user interface 18 or the like, for causing an indication of restricted access to be presented in conjunction with a screen display associated with the encounter. See block 34 of FIG. 2. In this regard, the computing device, such as the processing circuitry, may cause a variety of different types of indications of restricted access to be presented so as to alert the medical provider that records and documentation associated with the encounter are restricted and that access should be limited so as to reduce the likelihood of an inadvertent disclosure. In this regard, the computing device may cause the indication of restricted access to be presented in conjunction with any one or more of the various screen displays associated with the encounter.

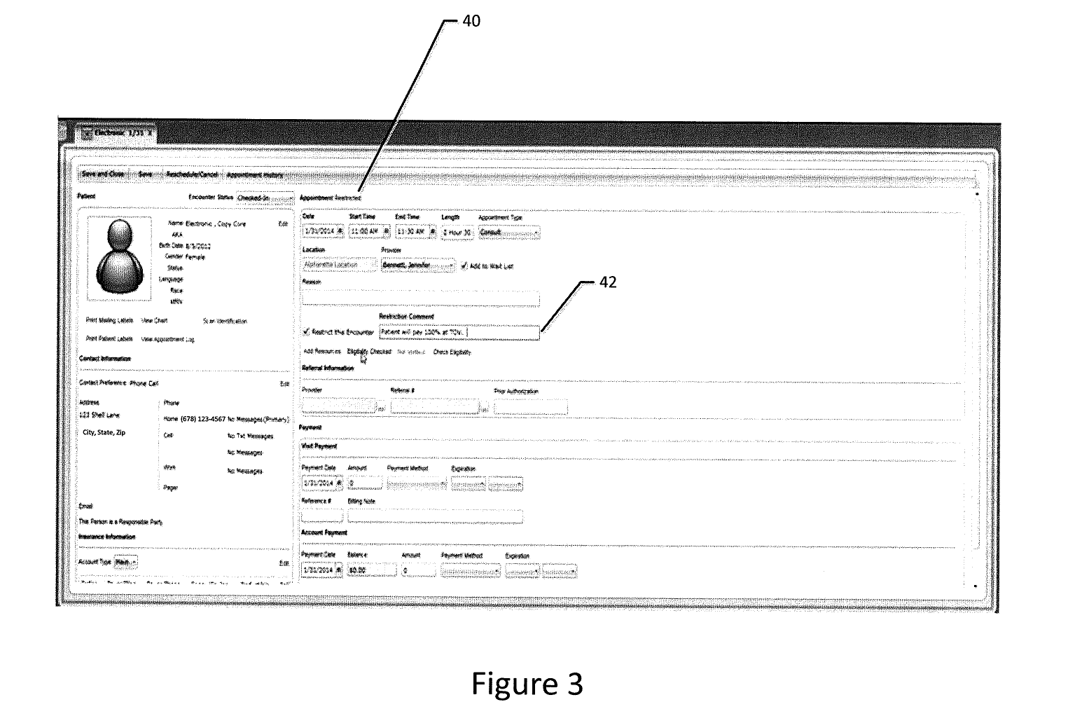

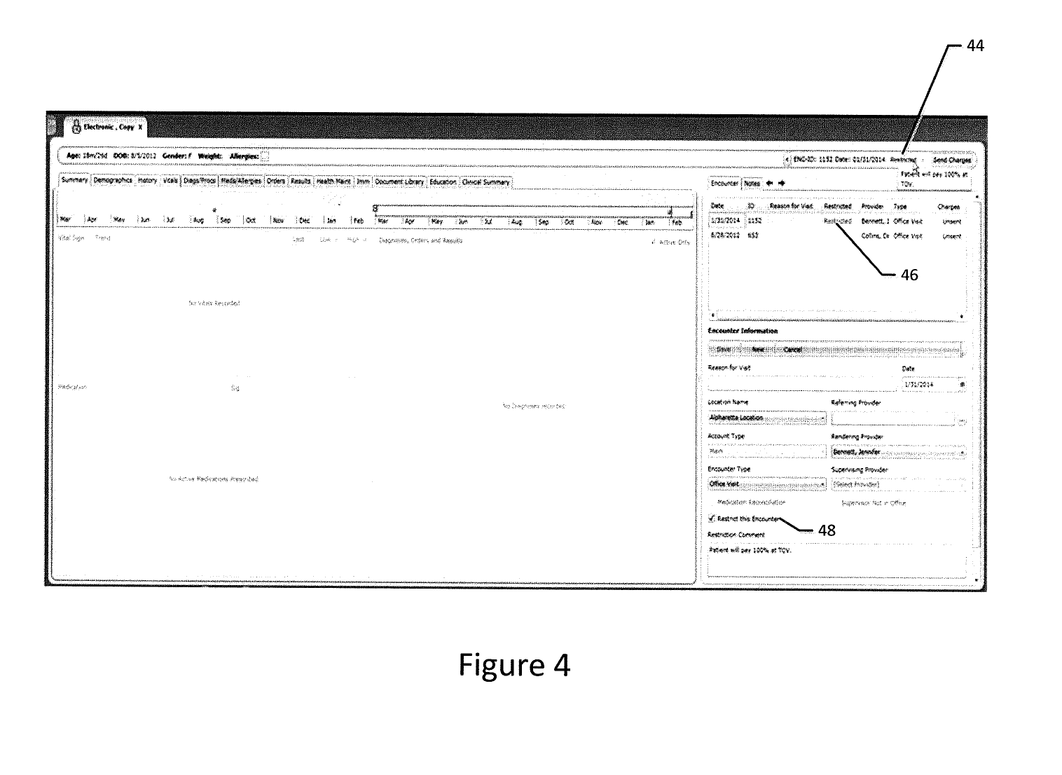

By way of example, FIG. 3 depicts a schedule view of an encounter for which access to the records and documentation is restricted. As shown, the indication 40 flags that the appointment is restricted. Additionally, the restriction comment 42 again indicates that the encounter is restricted and confirms that the patient will pay the entire bill at the time of visit (TOV). These indications serve to alert the medical provider as to the restrictions on access to records and documentation associated with the encounter. As another example, FIG. 4 depicts a chart/encounter view that includes an indication 44 flagging the encounter as being restricted. As shown in FIG. 4, by placing the cursor over the indication 44 that the encounter is restricted, an explanation as to the reason for the restriction, that is, the payment by the patient of the entire bill at the time of visit, may be provided. In the portion of the chart/encounter view that summarizes the recent encounters with the patient, an indication 46 may also be provided as to whether a particular encounter is restricted or not. In this regard, it is noted that not every encounter for a patient need be restricted, but only certain ones of the encounters may be restricted depending upon the patient's request and the patient's payment for services rendered during the respective encounter. As with the schedule view, the chart/encounter view may also provide restriction comments 48.

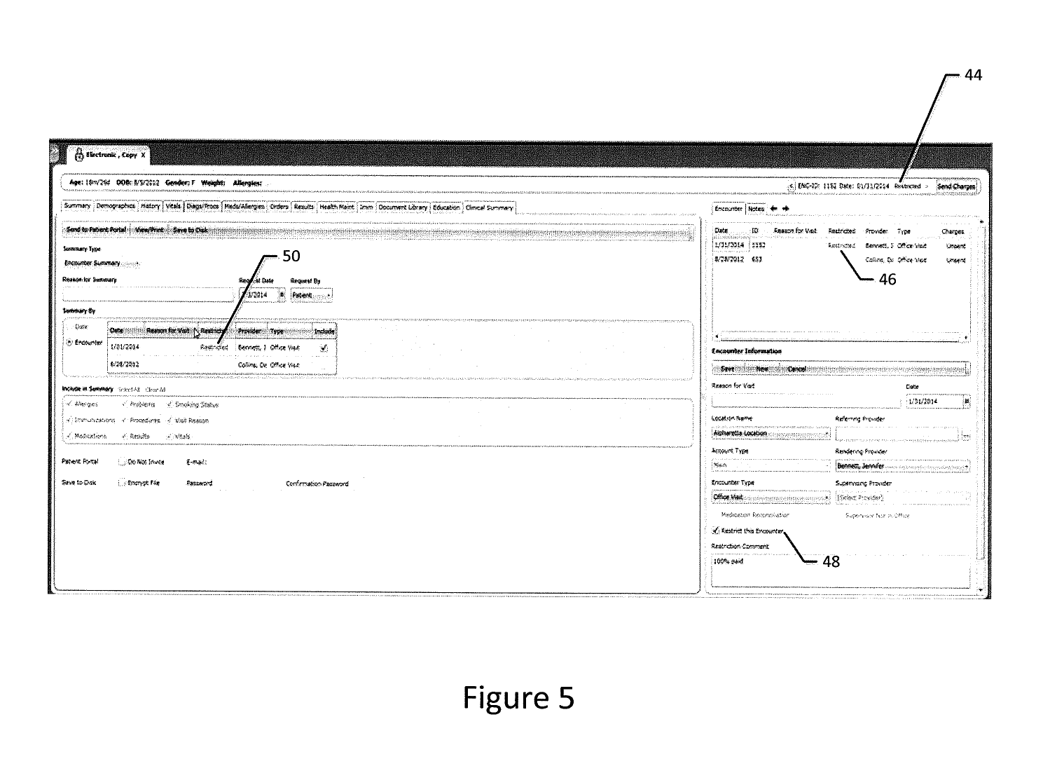

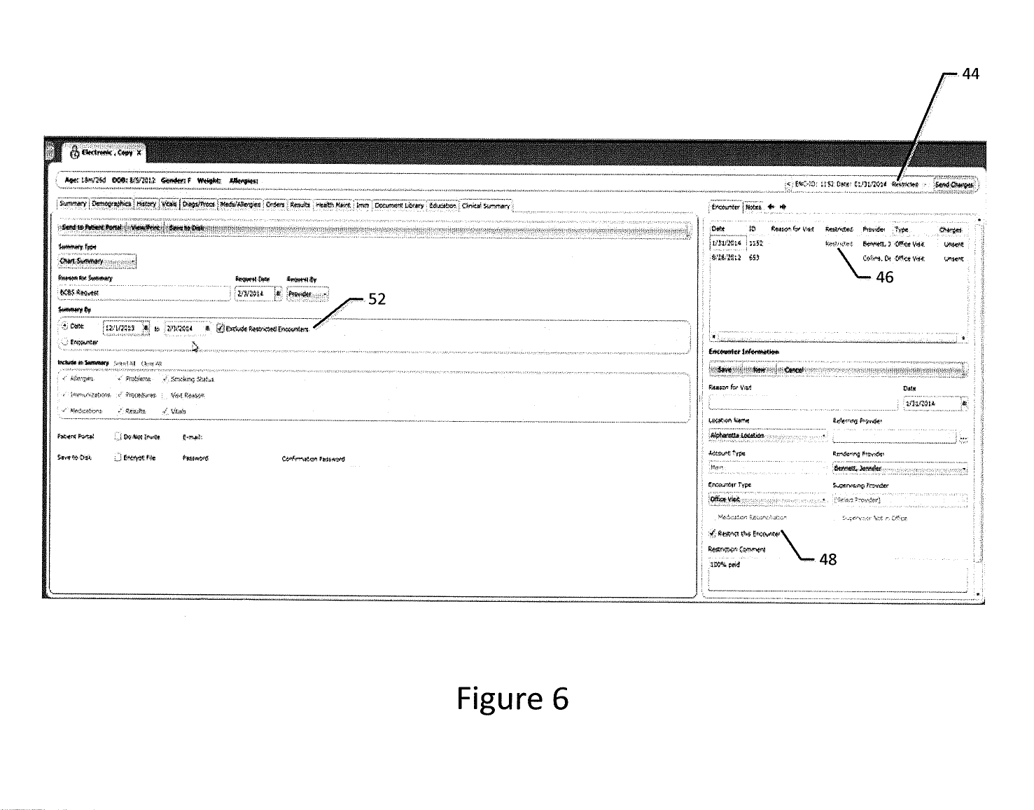

FIGS. 5 and 6 illustrate summaries of an encounter, such as an encounter summary in FIG. 5 and a chart summary in FIG. 6, that also provide indications as to the restrictions on access to records and documentation associated with the encounter. In this regard, the summaries of FIGS. 5 and 6 may include the same indications 44, 46 and 48 of restricted access as described above in conjunction with the chart/encounter view of FIG. 4. In addition, the encounter summary of FIG. 5 may include a summary of the encounters that may also indicate on an encounter-by-encounter basis at 50 as to whether or not respective encounters are restricted. Further, the chart summary of FIG. 6 may permit the patient's chart to be summarized across a range of dates and, if so, may permit the medical practice to include or exclude restricted encounters as shown at 52.

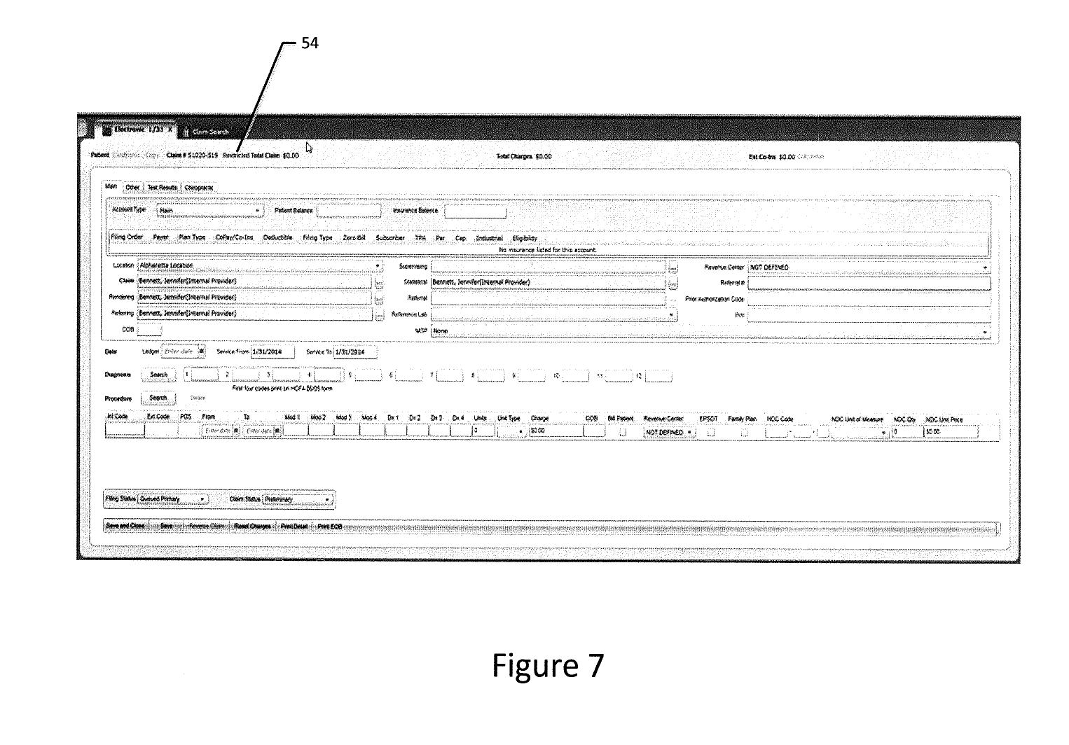

Finally, an example of a billing view for an encounter is depicted in FIG. 7. As shown by indication 54, the encounter that is the subject of the billing view may also be flagged to be associated with a restricted encounter. Although examples of various screen displays are depicted in FIGS. 3-7 and described above, the foregoing screen displays are merely examples and the computing device 10 may be configured to cause an indication of restricted access to be presented in a variety of other manners in accordance with other embodiments of the present invention. For example, the computing device, such as the processing circuitry 12, may be configured to cause an indication of restricted access to be presented in conjunction with a claim associated with the encounter, thereby alerting the medical provider as to the restricted nature of the subject matter of the encounter prior to submission of the claim to a payer.

As shown in block 36 of FIG. 2, the computing device 10 may also include means, such as the processing circuitry 12, the processor 14 or the like, for preventing records and documentation, such as claims, associated with the encounter to which access is restricted from being provided to a party associated with payment of claims for the patient. In this regard, the party associated with payment of claims for the patient may include an insurance carrier or other payer. In one embodiment, the computing device, such as the processing circuitry, may be configured such that an effort by a medical provider to submit a claim and/or associated records and documentation for an encounter to which access has been restricted may be prevented with the records and documentation not being transmitted. Instead, the computing device, such as the processing circuitry, the user interface 18 or the like, may be configured to cause a message to be presented indicating that access to the records and documentation associated with the encounter has been restricted and that the records and documentation have not been transmitted as instructed.

The records and documentation associated with an encounter may include not only the records and documentation compiled by the medical provider during the encounter, such as the chart, notes or the like, but also records and documentation associated with tests, procedures or the like that are associated with the encounter, such as by being ordered during the encounter, so long as the patient also provides payment in full for the tests, procedures or the like by their conclusion. As such, the foregoing discussion of restrictions on access to the records and documentation associated with an encounter applies equally to the tests, procedures or the like associated with the encounter for which access is restricted.

Further, a medical provider may generate reports that include information regarding a patient and a plurality of encounters, such as all of the encounters, that the medical provider has had with the patient. Although various types of such reports may be generated, a continuity of care document (CCD) is one example of a report that includes information regarding a plurality of encounters with the patient. In an instance in which access is restricted to records and documentation associated with an encounter, however, the computing device 10, such as the processing circuitry 12, the processor 14 or the like, may be configured to exclude information regarding the encounter to which access is restricted from that report that includes information regarding the patient including one or more other encounters with the patient. As such, the resulting report may not be as comprehensive as if the report included information regarding all of the encounters including those to which access is restricted, but the resulting report will comply with the request of the patient in that report will not provide information, such as records and documentation, associated with the encounter to which access is restricted. In one embodiment, the computing device, such as the processing circuitry, may be configured to receive input from the medical provider regarding whether to include information regarding an encounter to which access has been restricted in the report. For example, the summary encounter of FIG. 6 permits the medical provider to provide input, such as in the form of a check box at 52, regarding whether or not information regarding an encounter to which access has been restricted should be included or excluded from a summary report.

Depending upon the patient's request, the request for restricted access may apply to all records and documentation associated with an encounter or to only those records and documentation associated with a portion of the encounter with the records and documentation associated with another portion of the encounter not having any access restrictions placed thereupon. In this regard, the request by the patient for restricted access may specify whether the request applies to all records and documentation associated with the encounter or only the records and documentation associated with a portion of the encounter. As such, in the foregoing discussion regarding access restrictions for records and documentation associated with an encounter, the computing device 10, such as the processing circuitry 12, of an example embodiment in which a patient requests restrictions on the access to records and documentation associated with a portion of the encounter, but not the entirety of the encounter may correspondingly restrict access to the relevant portion of the records and documentation associated with the restricted portion of the encounter, while not restricting access to other records and documentation associated with the other, unrestricted portion of the encounter.

In one embodiment, the computing device 10, such as the processing circuitry 12, may separate an encounter in which access is restricted to one portion, but not another portion into two encounters. In this embodiment, a first of the newly created encounters is associated with that portion of the original encounter to which access is to be restricted, while a second of the newly created encounters is associated with that portion of the original encounter to which access is not to be restricted. As such, the computing device, such as the processing circuitry, of this example embodiment may restrict access to records and documentation associated with the first, newly created encounter, but not the second, newly created encounter in compliance with the request of the patient.

Following the encounter, a patient may eliminate the restrictions on access, e.g., lift the access restrictions. In this embodiment, the computing device 10 may include means, such as the processing circuitry 12, the processor 14, the user interface 18 or the like, for receiving a request from the patient to eliminate the restricted access. As with the initial request to restrict access, the request to eliminate the restricted access may be provided orally, in writing or otherwise. In response to the request to eliminate the restricted access, the computing device of this example embodiment may include means, such as the processing circuitry, the processor or the like, for providing access to the records and documentation associated with the encounter to the party associated with payment of claims for the patient. In this embodiment, if the payer subsequently provides payment for all or a portion of the services rendered during the encounter, the medical practice may, in turn, issue a refund to the patient of the same amount provided by the payer since the patient previously paid in full for the services rendered during the encounter. In response to the request to eliminate the restricted access, the computing device, such as the processing circuitry, of this example embodiment may also be configured to remove the indication of restricted access from the screen display(s) associated with the encounter and include information regarding the formerly restricted encounter in reports associated with the patient that include information, such as summary information, regarding a plurality of encounters.

As such, the method, computing device 10 and computer program product provide for selectively restricting access to information regarding an encounter. As such, the method, computing device and computer program product of an example embodiment permit a medical provider or other source of medical records and documentation to be alerted of a patient's request to restrict access to records and documentation and to correspondingly prevent those records and documentation from being provided to a party associated with payment of the claims for the encounter. Thus, the method, computing device and computer program product of an example embodiment may facilitate compliance with the HIPAA Omnibus rule.

As described above, FIG. 2 is a flowchart of a method, computing device 10 and computer program product according to example embodiments of the invention. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices 16 of a computing device and executed by processing circuitry 12 in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowchart support combinations of means for performing the specified functions and combinations of steps for performing the specified functions. It will also be understood that one or more blocks of the flowchart, and combinations of blocks in the flowchart, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processing circuitry 12 may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for restricting access to information regarding an encounter, the method comprising:
receiving a request from a patient to restrict access to records and documentation associated with at least a portion of an encounter;
causing, with processing circuitry, an indication of restricted access to be presented in conjunction with a screen display associated with the encounter; and
preventing records and documentation associated with the at least a portion of the encounter from being provided to a party associated with payment of claims for the patient.

2. A method according to claim 1 further comprising honoring the request by causing the indication of restricted access to be presented and by preventing records and documentation from being provided only in an instance in which the patient provides payment by a conclusion of the encounter.

3. A method according to claim 1 further comprising excluding the encounter from a report that provides information regarding the patient including one or more encounters with the patient.

4. A method according to claim 1 wherein preventing records and documentation associated with the at least a portion of the encounter from being provided comprises preventing information regarding tests associated with the encounter from being provided to the party associated with payment of claims for the patient.

5. A method according to claim 1 wherein causing an indication of restricted access to be presented comprises causing the indication of restricted access to be presented in conjunction with a schedule view, a chart view, an encounter view or a claim associated with the encounter.

6. A method according to claim 1 wherein the party associated with payment of claims for the patient comprises an insurance carrier or other payer.

7. A method according to claim 1 further comprising:
receiving a request from the patient to eliminate the restricted access following the receiving, causing and preventing steps; and
in response to the request to eliminate the restricted access, providing access to the records and documentation associated with the at least a portion of the encounter to the party associated with payment of claims for the patient.

8. A computing device for restricting access to information regarding an encounter, the computing device comprising processing circuitry configured to:
receive a request from a patient to restrict access to records and documentation associated with at least a portion of an encounter;
cause an indication of restricted access to be presented in conjunction with a screen display associated with the encounter; and
prevent records and documentation associated with the at least a portion of the encounter from being provided to a party associated with payment of claims for the patient.

9. A computing device according to claim 8 wherein the processing circuitry is further configured to honor the request by causing the indication of restricted access to be presented and by preventing records and documentation from being provided only in an instance in which the patient provides payment by a conclusion of the encounter.

10. A computing device according to claim 8 wherein the processing circuitry is further configured to exclude the encounter from a report that provides information regarding the patient including one or more encounters with the patient.

11. A computing device according to claim 8 wherein the processing circuitry is configured to prevent records and documentation associated with the at least a portion of the encounter from being provided by preventing information regarding tests associated with the encounter from being provided to the party associated with payment of claims for the patient.

12. A computing device according to claim 8 wherein the processing circuitry is configured to cause an indication of restricted access to be presented by causing the indication of restricted access to be presented in conjunction with a schedule view, a chart view, an encounter view or a claim associated with the encounter.

13. A computing device according to claim 8 wherein the party associated with payment of claims for the patient comprises an insurance carrier or other payer.

14. A computing device according to claim 8 wherein the processing circuitry is further configured to:
receive a request from the patient to eliminate the restricted access following the receiving, causing and preventing steps; and
in response to the request to eliminate the restricted access, provide access to the records and documentation associated with the at least a portion of the encounter to the party associated with payment of claims for the patient.

15. A computer program product for restricting access to information regarding an encounter, the computer program product comprising a non-transitory computer readable medium having program code stored thereon, the program code comprising program code instructions configured, upon execution, to:
receive a request from a patient to restrict access to records and documentation associated with at least a portion of an encounter;
cause an indication of restricted access to be presented in conjunction with a screen display associated with the encounter; and
prevent records and documentation associated with the at least a portion of the encounter from being provided to a party associated with payment of claims for the patient.

16. A computer program product according to claim 15 wherein the program code further comprises program code instructions configured, upon execution, to honor the request by causing the indication of restricted access to be presented and by preventing records and documentation from being provided only in an instance in which the patient provides payment by a conclusion of the encounter.

17. A computer program product according to claim 15 wherein the program code further comprises program code instructions configured, upon execution, to exclude the encounter from a report that provides information regarding the patient including one or more encounters with the patient.

18. A computer program product according to claim 15 wherein the program code instructions configured to prevent records and documentation associated with the at least a portion of the encounter from being provided comprise program code instructions configured to prevent information regarding tests associated with the encounter from being provided to the party associated with payment of claims for the patient.

19. A computer program product according to claim 15 wherein the program code instructions configured to cause an indication of restricted access to be presented comprise program code instructions configured to cause the indication of restricted access to be presented in conjunction with a schedule view, a chart view, an encounter view or a claim associated with the encounter.

20. A computer program product according to claim 15 wherein the party associated with payment of claims for the patient comprises an insurance carrier or other payer.
